(19) United States
(12) Patent Application Publication
(10) Pub. No.: US 2026/0163368 A1
(43) Pub. Date: Jun. 11, 2026

(54) HUB AND OPERATION METHOD THEREOF

(71) Applicant: Gearmax CO., LTD., Taoyuan City (TW)

(72) Inventors: Tsung-Hsun WU, Taoyuan City (TW); Chun-Wei WEN, Taoyuan City (TW); Sung-Huan TSAI, Taoyuan City (TW)

(21) Appl. No.: 19/351,324

(22) Filed: Oct. 7, 2025

Related U.S. Application Data
(60) Provisional application No. 63/730,432, filed on Dec. 10, 2024.

(30) Foreign Application Priority Data
May 12, 2025 (TW) 114117777

(51) Int. Cl. H02J 1/14; H01R 13/66; H01R 25/00

(52) U.S. Cl. CPC H02J 1/14; H01R 13/6683; H01R 25/003

(57) ABSTRACT

The hub comprises a first connection port coupled to a first electronic device; a second connection port coupled to a power supply device; a third connection port coupled to a second electronic device; a first detection unit for detecting current and voltage information of the first electronic device; a second detection unit for detecting current and voltage information of the power supply device; a third detection unit for detecting current and voltage information of the second electronic device; and a control unit for generating the available power of the power supply device and the required power of the second electronic device according to the current and voltage information of the power supply device and the second electronic device to dynamically allocate the available power to the second electronic device and the first electronic device according to the required power.

### RELATED APPLICATIONS

This application claims priority to Taiwan Application Serial Number 114117777, filed on May 12, 2025, and to US provisional application Ser. No. 63/730,432, filed on Dec. 10, 2024, which are herein incorporated by reference.

### BACKGROUND

### Field of Invention

The present disclosure relates to a hub, and more particularly to a hub and an operation method thereof that is capable of dynamically allocating power to each connection port.

### Description of Related Art

As the types of mobile devices increase, if the mains power is used in combination with a transformer to power the mobile devices, when multiple mobile devices need to be powered at the same time, multiple transformers must be used, which is not only inconvenient to use but also increases the cost of use.

Therefore, power is often transmitted through a Universal Serial Bus Type-C (USB-C) hub to power different mobile devices, such as smartphones, tablets, and laptops. However, although traditional USB-C hubs can provide multiple USB ports to power different mobile devices simultaneously, each USB port can only provide a rated power, which cannot meet the power requirements of different mobile devices at the same time.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

One objective of the present disclosure is to provide a hub, comprises a first connection port, coupled to a first electronic device; a second connection port, coupled to a power supply device; at least one third connection port, coupled to at least one second electronic device; a first detection unit, coupled to the first connection port, for detecting current and voltage information of the first electronic device; a second detection unit, coupled to the at least one second connection port, for detecting current and voltage information of the power supply device; a third detection unit, coupled to the third connection port, for detecting current and voltage information of the at least one second electronic device; and a control unit, coupled to the first detection unit, the second detection unit and the third detection unit, for generating the available power of the power supply device and the required power of the at least one second electronic device according to the current and voltage information of the power supply device and the current and voltage information of the at least one second electronic device, so as to dynamically allocate the available power to the at least one second electronic device and the first electronic device according to the required power.

In some embodiments, the first connection port is a universal serial bus C-type male connector.

In some embodiments, the second connection port is a USB Type-C port.

In some embodiments, at least one third connection port is a USB Type-A connection port.

In some embodiments, the power supply device is used to provide a DC power supply.

In some embodiments, the hub further includes a protection element coupled to the first detection unit, the second detection unit, and the third detection unit to provide over-current and over-voltage protection.

In some embodiments, the step that the control unit dynamically allocates the available power to the at least one second electronic device and the first electronic device according to the required power further comprises comparing the required power with a plurality of preset power ranges to select a first preset power range that meets the required power from the plurality of preset power ranges, and dynamically allocating a first available power corresponding to the first preset power range to the first electronic device according to the first preset power range.

One objective of the present disclosure is to provide a hub operation method. The hub includes a first connection port for coupling a first electronic device, a second connection port for coupling a power supply device, and at least one third connection port for coupling at least one second electronic device. The hub operation method comprises detecting first current and voltage information of the at least second electronic device and detecting first current and voltage information of the power supply device; generating a first available power of the power supply device according to the first current and voltage information of the power supply device and a first required power of the at least second electronic device according to the first current and voltage information of the at least second electronic device; and dynamically allocating the first available power to the at least second electronic device and the first electronic device according to the first required power.

In some embodiments, after generating the first available power of the power supply device and the first required power of the at least one second electronic device, the hub operation method further comprises detecting the first current and voltage information of the first electronic device; determining whether the first electronic device is coupled to the first connection port according to the first current and voltage information of the first electronic device; and dynamically allocating the first available power to the at least one second electronic device according to the first required power when the first electronic device is not coupled to the first connection port.

In some embodiments, when the first electronic device is coupled to the first connection port, the hub operation method further comprises comparing the first required power and a plurality of preset power ranges to select a first preset power range that meets the first required power from the plurality of preset power ranges; and dynamically allocating an available power to the first electronic device corresponding to the first preset power range.

In some embodiments, after dynamically allocating the first available power to the at least one second electronic device and the first electronic device according to the first required power, the hub operation method further comprises detecting the second current and voltage information of the at least one second electronic device and detecting the second current and voltage information of the power supply device; determining whether the coupling relationship between the at least one second electronic device and the power supply device and the at least one third connection port and the second connection port has changed according to the second current and voltage information of the at least one second electronic device and the second current and voltage information of the power supply device; generating the second available power of the power supply device and the second required power of the at least one second electronic device according to the second current and voltage information of the power supply device and the second current and voltage information of the at least one second electronic device when the coupling relationship changes; and dynamically allocating the second available power to the at least one second electronic device and the first electronic device according to the second required power.

The present invention optimizes power usage by dynamically detecting whether or not an electronic device is connected to a port and the real-time power requirement of the electronic device to dynamically allocating the power provided to the port at the highest rating of the port.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram illustrating the appearance of a USB Type-C hub according to an embodiment of the present invention.

FIG. 2 is a schematic diagram illustrating the circuit structure of a USB Type-C hub according to an embodiment of the present invention.

FIG. 3 is a schematic diagram illustrating a power setting range according to an embodiment of the present invention.

FIG. 4 is a flow chart of dynamic power configuration method according to an embodiment of the present invention.

### DESCRIPTION OF THE EMBODIMENTS

To make the contents of the present disclosure more thorough and complete, the following illustrative description is given with regard to the implementation aspects and embodiments of the present disclosure, which is not intended to limit the scope of the present disclosure. The features of the embodiments and the steps of the method and their sequences that constitute and implement the embodiments are described. However, other embodiments may be used to achieve the same or equivalent functions and step sequences.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

Typically, when a Universal Serial Bus Type-C (USB Type-C) hub is used to transmit power to power different mobile devices, the power that each port of the USB Type-C hub can provide is rated and cannot take into account the power requirements of different mobile devices. Therefore, the present invention provides a USB Type-C hub with dynamically configurable output power. By dynamically detecting whether each connection port of the hub is connected to an electronic device and the power consumption of the connected electronic device, the power provided by each connection port is dynamically allocated under the maximum power rating of each connection port to optimize power usage.

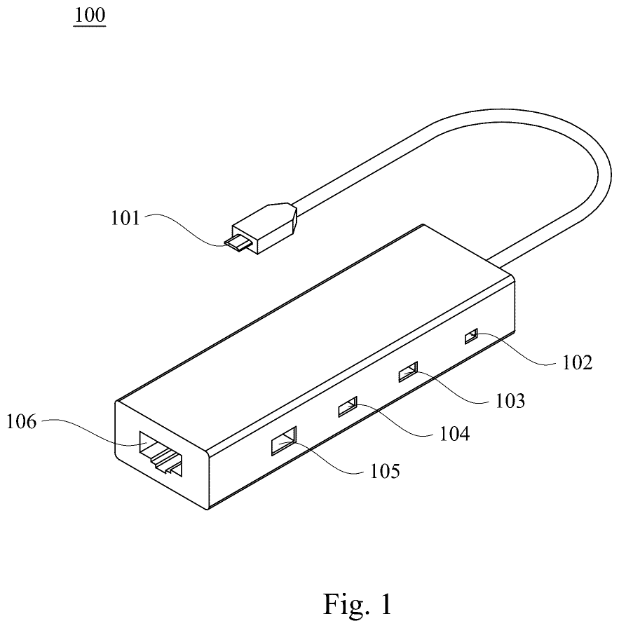

FIG. 1 is a schematic diagram illustrating the appearance of a USB Type-C hub according to an embodiment of the present invention. The USB Type-C hub 100 has a first connection port 101, a second connection port 102, a third connection port 103, a fourth connection port 104, a fifth connection port 105 and a sixth connection port 106. In some embodiments, the first connection port 101 is a universal serial bus Type-C male connector. The second connection port 102 is a USB Type-C connection port. The third connection port 103 and the fourth connection port 104 are both USB Type-A connection ports. The fifth connection port 105 is an RJ45 connection port. The sixth connection port 106 is a High Definition Multimedia Interface (HDMI) connection port. In some embodiments, the USB Type-C hub 100 can electrically couple to a USB port of an electronic device through the first connection port 101, electrically couple to a mobile device through the third connection port 103 and the fourth connection port 104, and receive power through the second connection port 102 to power the electronic device and the mobile device. In some embodiments, the input power source is a DC power source provided by an external power conversion device, or directly provided by an energy storage device. The electronic device is a desktop computer or a notebook computer. The mobile device is a mobile phone, a tablet computer or a storage device. It is worth noting that the number and type of the above-mentioned connection ports are only one implementation of the present invention and are not intended to limit the present invention. In other embodiments, the USB Type-C hub 100 may be configured with different numbers and types of connection ports.

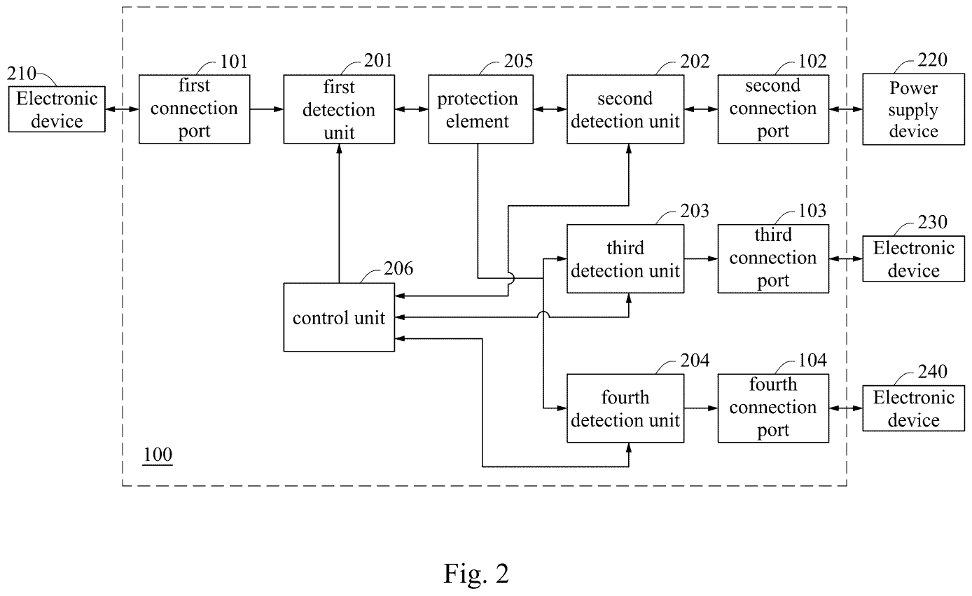

FIG. 2 is a schematic diagram showing a circuit structure of a USB Type-C hub according to an embodiment of the present invention. Please refer to FIG. 1 and FIG. 2. In order to dynamically allocate the power provided by each connection port, a detection unit is set at the connection port to detect whether there is an external device connected to the connection port and the power consumption of the external device. In some embodiments, because the fifth connection port 105 is an RJ45 connection port and the sixth connection port 106 is a high-definition multimedia interface connection port with a fixed reactive power, the following uses the example of setting a detection unit at the first connection port 101, the second connection port 102, the third connection port 103 and the fourth connection port 104 to illustrate the application of the present application. However, in other embodiments, the detection unit may be disposed at both the fifth connection port 105 and the sixth connection port 106.

As shown in FIG. 2, only the first connection port 101, the second connection port 102, the third connection port 103 and the fourth connection port 104 are depicted. In some embodiments, the USB Type-C hub 100 includes a first connection port 101, a second connection port 102, a third connection port 103, a fourth connection port 104, a first detection unit 201, a second detection unit 202, a third detection unit 203, a fourth detection unit 204, a protection element 205 and a control unit 206.

The first connection port 101 is an USB Type-C male connector. It is used to connect to an external electronic device 210, such as a desktop computer or a notebook computer, to perform data transmission or power transmission. The first detection unit 201 is coupled to the first connection port 101 and receives power input from the external power supply device 220 at the second connection port 102 to supply power to the electronic device 210. In one embodiment, the first detection unit 201 can be used to detect whether or not the electronic device 210 is coupled to the first connection port 101, and to obtain working power information of the electronic device 210, such as current and voltage information, to transmit to the control unit 206 when the electronic device 210 is coupled to the first connection port 101.

The second connection port 102 is a USB Type-C connection port. The second connection port 102 can be used to receive power input from an external power supply device 220. The second detection unit 202 is coupled to the second connection port 102 to detect whether or not the external power supply device 220 is coupled to the second connection port 102, and to obtain working power information of the external power supply device 220, such as current and voltage information, to transmit to the control unit 206 when the external power supply device 220 is coupled to the second connection port 102. In some embodiments, the external power supply device 220 is a mains power source that has been converted into a DC power source, or an energy storage device that provides a DC power source.

The third connection port 103 and the fourth connection port 104 are both USB Type-A connection ports, which are used to connect to the electronic devices 230 and 240 respectively for data transmission or power transmission. The third detection unit 203 is coupled to the third connection port 103 t to detect whether or not the electronic device 230 is coupled to the third connection port 103, and to obtain working power information, such as current and voltage information, of the electronic device 230 to transmit to the control unit 206 when the electronic device 230 is coupled to the third connection port 103. The fourth detection unit 204 is coupled to the fourth connection port 104 to detect whether or not the electronic device 240 is coupled to the fourth connection port 104, and to obtain working power information of the electronic device 240, such as current and voltage information, to transmit to the control unit 206 when the electronic device 240 is coupled to the fourth connection port 104. In some embodiments, the electronic devices 230 and 240 are tablet computers or smart handheld devices.

The protection element 205 is coupled to the first detection unit 201, the second detection unit 202, the third detection unit 203 and the fourth detection unit 204 to provide over-current and over-voltage protection to prevent the electronic devices 210, 230, 240 from life shortened or being damaged because of abnormal power supply current input from the external power supply device 220.

The control unit 206 is used to receive the current and voltage information returned by the first detection unit 201, the second detection unit 202, the third detection unit 203 and the fourth detection unit 204 to determine whether the corresponding connection port is coupled to an electronic device, and to calculate the power consumption of the corresponding electronic device when the electronic device is coupled to the corresponding connection port. In some embodiments, the control unit 206 stores a plurality of power setting ranges. The control unit 206 dynamically allocates the input power of the external power supply device 220 to the electronic device according to the comparison result between the power consumption of the electronic device and the plurality of power setting ranges. In some embodiments, the control unit 206 is a central processing unit (CPU), a microprocessor (MCU), or other devices with equivalent functions. The above embodiment of the control unit 206 is for illustrative purposes only, and various hardware components such as circuits or modules that can implement the control unit 206 are within the scope of this application.

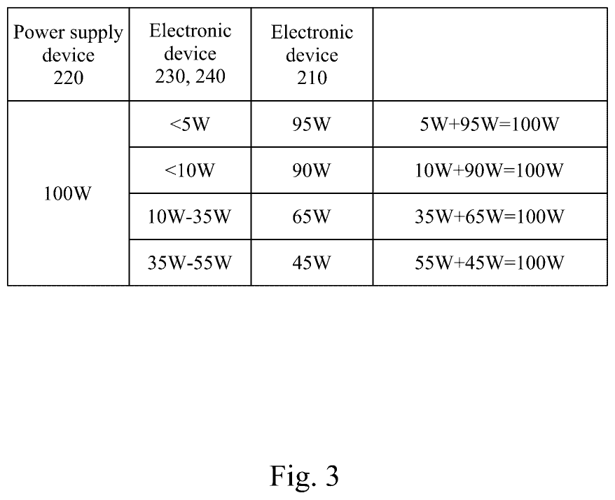

FIG. 3 is a schematic diagram showing a power setting range according to an embodiment of the present invention. Each power setting range corresponds to an available power value. As shown in FIG. 3, in one embodiment, the power setting range is the power value required by the USB Type-C hub 100, that is, the power range is required by the electronic device 230 and the electronic device 240. The available power value is the power value that can provide to the electronic device 210. Accordingly, the power supply device 220 can provide power of 100 watts. When the power setting range is less than 5 watts, the available power value is 95 watts. When the power setting range is from 5 watts to less than 10 watts, the available power value is 90 watts. When the power setting range is from 10 watts to less than 35 watts, the available power value is 65 watts. When the power setting range is from 35 watts to less than 55 watts, the power provided is 45 watts. However, the present invention is not limited thereto. In other implementations, different power setting ranges may be set.

In some embodiments, the control unit 206 receives the current and voltage information sent back by the second detection unit 202 to determine whether or not the power supply device 220 is coupled to the second connection port 102 based on the current and voltage. When the control unit 206 determine that the power supply device 220 is coupled to the second connection port 102, the control unit 206 can calculate the watts provided by the power supply device 220 based on the current and voltage information. In an embodiment, the control unit 206 determines that the power supply device 220 can provide an output of 100 watts. In another embodiment, the control unit 206 receives the current and voltage information sent back by the third detection unit 203 and the fourth detection unit 204 to determine whether or not the electronic device 230 is coupled to the third connection port 103 and the electronic device 240 is coupled to the fourth connection port 104. When the control unit 206 determines that the electronic device 230 is coupled to the third connection port 103 and the electronic device 240 is coupled to the fourth connection port 104, the control unit 206 can calculate the watts required by the electronic 230 and the electronic device 240 based on the current and voltage information. In an embodiment, both the electronic device 230 and the electronic device 240 require 34 watts of power based on the current and voltage information. Accordingly, the control unit 206 can compare the 34 watts of power required by the electronic device 230 and the electronic device 240 with the power setting ranges illustrated in FIG. 3 to dynamically allocate the 34 watts of the output of 100 watts from the power supply device 220 to the electronic device 230 and the electronic device 240, and dynamically allocate the 65 watts of the output of 100 watts from the power supply device 220 to the electronic device 210.

In another embodiment, the control unit 206 receives the current and voltage information sent back by the third detection unit 203 and the fourth detection unit 204 to determine whether or not the electronic device 230 is coupled to the third connection port 103 and the electronic device 240 is coupled to the fourth connection port 104. When the control unit 206 determines that the electronic device 230 does not be coupled to the third connection port 103 and the electronic device 240 is coupled to the fourth connection port 104, the control unit 206 can calculate the watts required by the electronic 240 based on the current and voltage information. In an embodiment, the electronic device 240 requires 7 watts of power based on the current and voltage information. Accordingly, the control unit 206 can compare the 7 watts of power required by the electronic device 240 with the power setting ranges illustrated in FIG. 3 to dynamically allocate the 7 watts of the output of 100 watts from the power supply device 220 to the electronic device 240, and dynamically allocate the 90 watts of the output of 100 watts from the power supply device 220 to the electronic device 210.

In another embodiment, after dynamically allocating the 7 watts of the output of 100 watts from the power supply device 220 to the electronic device 240, and dynamically allocating the 90 watts of the output of 100 watts from the power supply device 220 to the electronic device 210, if an electronic device 230 is coupled to the third connection port 103, the control unit 206 can dynamically receive the current and voltage information sent back by the third detection unit 203 to calculate the watts required by the electronic 230 based on the current and voltage information. In an embodiment, the electronic device 230 requires 17 watts of power based on the current and voltage information. Accordingly, the control unit 206 can again calculate that the electronic device 230 and the electronic device 240 require a total of 24 watts of power. Then, the control unit 206 can compare the 24 watts of power required by the electronic device 230 and the electronic device 240 with the power setting ranges illustrated in FIG. 3 to dynamically allocate the 7 watts of the output of 100 watts from the power supply device 220 to the electronic device 240, dynamically allocate the 17 watts of the output of 100 watts from the power supply device 230, and the 90 watts originally allocated to the electronic device 210 is dynamically corrected to 65 watts.

In another embodiment, after dynamically allocating the 34 watts of the output of 100 watts from the power supply device 220 to the electronic device 230 and the electronic device 240, and dynamically allocating the 65 watts of the output of 100 watts from the power supply device 220 to the electronic device 210, if the control unit 206 calculates that the electronic device 210 only requires 50 watts of power based on the current and voltage information dynamically received from the first detection unit 201, and the power required by the electronic device 230 and the electronic device 240 remain unchanged, the control unit 206 can dynamically control the power supply device 220 to reduce the output power, thereby further reducing power loss.

It is worth noting that the RJ45 connection port of the fifth connection port 105 and the high-definition multimedia interface connection port of the sixth connection port 106 can also use the above method to perform dynamic power configuration, which will not be described in detail here.

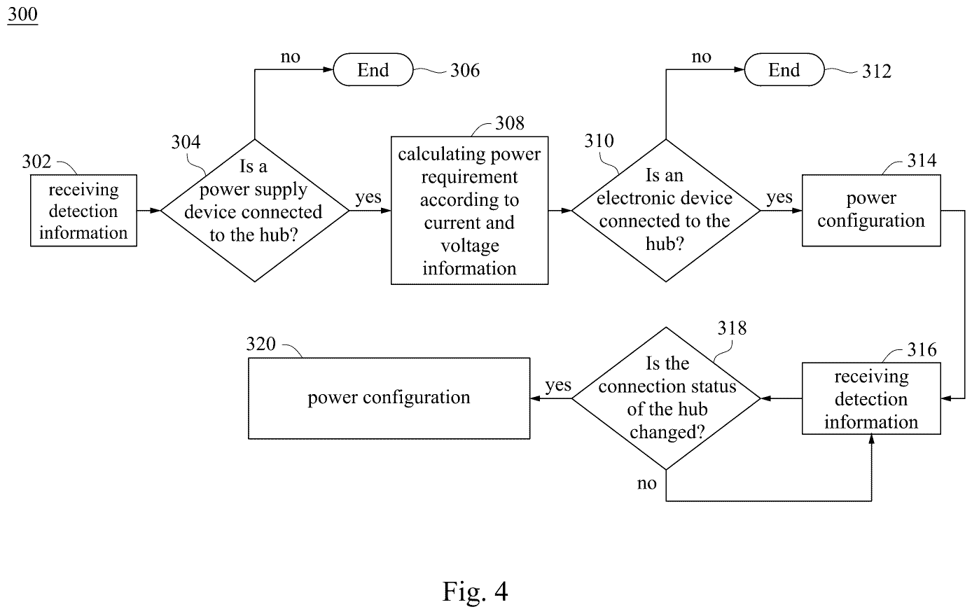

FIG. 4 is a schematic flow chart of dynamic power configuration method according to an embodiment of the present invention. It should be understood that the operations of the dynamic power configuration method 300 mentioned in this embodiment, except for those whose order is specifically described, can be adjusted in order according to actual needs, and can even be executed simultaneously or partially simultaneously. Furthermore, in different embodiments, these operations may be adaptively increased, replaced, and/or omitted. Please also refer to FIG. 2, FIG. 3 and FIG. 4.

The dynamic power configuration method 300 first receives a detection information in step 302. In some embodiments, the control unit 206 receives the current and voltage information sent back by the second detection unit 202, the third detection unit 203, and the fourth detection unit 204.

In step 304, a determination step is performed to determine whether or not a power supply device is connected to the USB Type-C hub 100. In some embodiments, the control unit 206 determines whether or not a power supply device 220 is coupled to the second connection port 102 of the USB Type-C hub 100 according to the current and voltage information sent back by the second detection unit 202.

If the power supply device 220 does not be coupled to the second connection port 102 of the USB Type-C hub 100, the step 306 is performed to end the dynamic power configuration process.

In the contrary, if the power supply device 220 is coupled to the second connection port 102 of the USB Type-C hub 100, the step 308 is performed to calculate the power requirement according to the current and voltage information. In some embodiments, the control unit 206 calculates the power that the power supply device 220 can provide based on the current and voltage information sent back by the second detection unit 202, and calculates the power required by the electronic device 230 and the electronic device 240 based on the current and voltage information sent back by the third detection unit 203 and the fourth detection unit 204.

In step 310, a determination step is performed to determine whether or not an electronic device is connected to the USB Type-C hub 100. In some embodiments, the control unit 206 determines whether or not an electronic device 210 is coupled to the first connection port 101 according to the current and voltage information sent back by the first detection unit 201. In some embodiments, the electronic device 210 is a computer.

If the electronic device 210 does not be coupled to the first connection port 101, the step 312 is performed to end the dynamic power configuration process.

On the contrary, if the electronic device 210 is coupled to the first connection port 101, the step 314 is performed to perform the dynamic power configuration. In some embodiments, the power configuration for the electronic device 210 is generated according to the power required by the electronic device 230 and the electronic device 240 and the power that the power supply device 220 can provide, and is compared with the power setting range.

In step 316, a detection information is received. In some embodiments, the control unit 206 receives the current and voltage information sent back by the second detection unit 202, the third detection unit 203, and the fourth detection unit 204.

In step 318, a determination step is performed to determine whether or not the connection status of the USB Type-C hub 100 is changed. In some embodiments, the control unit 206 determines whether or not the electronic devices 230, 240 and the power supply device 220 connected to the second connection port 102, the third connection port 103 and the fourth connection port 104 are disconnected or are replaced with different electronic devices based on the current and voltage information sent back by the second detection unit 202, the third detection unit 203 and the fourth detection unit 204.

If the connection status of the USB Type-C hub 100 does not be changed, that is, the second connection port 102, the third connection port 103 and the fourth connection port 104 are still coupled to the original electronic device 230, the electronic device 240 and the power supply device 220, the step 316 is performed again. On the contrary, If the connection status of the USB Type-C hub 100 is changed, that is, the electronic device 230, the electronic device 240 and the power supply device 220 coupled to the second connection port 102, the third connection port 103 and the fourth connection port 104 are disconnected or are replaced with different electronic devices, the step 320 is performed to calculate the power requirement according to the detection information and the dynamic power configuration is performed again. In some embodiments, for example, the processes of steps 304 to 318 are performed again.

Accordingly, the present invention optimizes power usage by dynamically detecting whether or not an electronic device is connected to a port and the real-time power requirement of the electronic device to dynamically allocating the power provided to the port at the highest rating of the port.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A hub, comprising:
a first connection port coupled to a first electronic device;
at least one second connection port coupled to a power supply device;
at least one third connection port coupled to at least one second electronic device;
a first detection unit coupled to the first connection port for detecting current and voltage information of the first electronic device;
a second detection unit coupled to the at least one second connection port for detecting current and voltage information of the power supply device;
a third detection unit coupled to the third connection port for detecting current and voltage information of the at least one second electronic device; and
a control unit coupled to the first detection unit, the second detection unit and the third detection unit for generating an available power of the power supply device according to the current and voltage information of the power supply device and an required power of the at least one second electronic device according to the current and voltage information of the at least one second electronic device, so as to dynamically allocate the available power to the at least one second electronic device and the first electronic device according to the required power.

2. The hub as claimed in claim 1, wherein the first connection port is a USB Type-C male connector.

3. The hub as claimed in claim 1, wherein the second connection port is a USB Type-C connection port.

4. The hub as claimed in claim 1, wherein the at least one third connection port is a USB Type A connection port.

5. The hub as claimed in claim 1, wherein the power supply device provides a DC power supply.

6. The hub as claimed in claim 1, further comprises a protection element coupled to the first detection unit, the second detection unit and the third detection unit to provide over-current and over-voltage protection.

7. The hub as claimed in claim 1, wherein the control unit dynamically allocates the available power to the at least one second electronic device and the first electronic device according to the required power, further comprising:
comparing the required power with a plurality of preset power ranges to select a first preset power range that meets the required power from the plurality of preset power ranges; and
dynamically allocating a first available power corresponding to the first preset power range to the first electronic device.

8. An operation method for a hub, wherein the hub comprises a first connection port coupled to a first electronic device, a second connection port coupled to a power supply device, and at least one third connection port coupled to at least one second electronic device, the operation method comprising:
detecting a first current and voltage information of the at least one second electronic device and a first current and voltage information of the power supply device;
generating a first available power of the power supply device and a first required power of the at least one second electronic device according to the first current and voltage information of the power supply device and the first current and voltage information of the at least one second electronic device; and
dynamically allocating the first available power to the at least one second electronic device and the first electronic device according to the first required power.

9. The operation method as claimed in claim 8, wherein after generating the first available power of the power supply device and the first required power of the at least one second electronic device, further comprising:
detecting a first current and voltage information of the first electronic device;
determining whether the first electronic device is coupled to the first connection port according to the first current and voltage information of the first electronic device; and
dynamically allocating the first required power to the at least one second electronic device according to the first available power when the first electronic device is not coupled to the first connection port.

10. The operation method as claimed in claim 9, wherein when the first electronic device is coupled to the first connection port, further comprising:
comparing the first required power with a plurality of preset power ranges to select a first preset power range that meets the first required power from the plurality of preset power ranges; and
dynamically allocating a power corresponding to the first preset power range to the first electronic device.

11. The operation method as claimed in claim 8, wherein after dynamically allocating the first available power to the at least one second electronic device and the first electronic device according to the first required power, further comprising:
detecting a second current and voltage information of the at least one second electronic device and a second current and voltage information of the power supply device;
determining whether coupling relationship between the at least one second electronic device and the at least one third connection port, or between the power device and the second connection port is changed according to the second current and voltage information of the at least one second electronic device and the second current and voltage information of the power device;
generating a second available power of the power supply device according to the second current and voltage information of the power supply device and a second required power of the at least one second electronic device according to the second current and voltage information of the at least one second electronic device when the coupling relationship changes; and
dynamically allocating the second available power to the at least one second electronic device and the first electronic device according to the second required power.

12. The operation method as claimed in claim 8, wherein the first connection port is a USB Type-C male connector.

13. The operation method as claimed in claim 8, wherein the second connection port is a USB Type-C connection port.

14. The operation method as claimed in claim 8, wherein the at least one third connection port is a USB Type A connection port.

15. The operation method as claimed in claim 8, wherein the power supply device provides a DC power supply.
